(19) United States
(12) Patent Application Publication
(10) Pub. No.: US 2009/0013879 A1
(43) Pub. Date: Jan. 15, 2009

(54) COOKING ACCESSORY FOR A STEAM COOKING DEVICE

(75) Inventors: Philippe Dumoux, Gemeaux (FR); Nicolas Pretre, Dijon (FR)

Correspondence Address: BROWDY AND NEIMARK, P.L.L.C.;624 NINTH STREET, NW, SUITE 300, WASHINGTON, DC, 20001-5303, US

(73) Assignee: SEB S.A., Ecully (FR)

(21) Appl. No.: 12/278,260

(22) PCT Filed: Feb. 1, 2007
(86) PCT No.: PCT/FR07/00190

§ 371 Date: Aug. 4, 2008

(30) Foreign Application Priority Data
Feb. 3, 2006 (FR) 0600996

(51) Int. Cl. A47J 27/05

(52) U.S. Cl. 99/410; 99/415

(57) ABSTRACT

Cooking accessory (1) especially for use in a steam cooking device, said cooking accessory (1) comprising a cooking receptacle and a zone for the passage of steam (6). Specifically according to the invention, the cooking accessory (1) is reversible, and the cooking accessory (1) has in an inverted position a cooking zone (12) adjacent to a juice collecting zone (10), the cooking zone (12) and the juice collecting zone (10) having no through-flow passages.

The present invention relates to the technical field of cooking accessories. The present invention relates particularly, though not exclusively, to a cooking accessory for a steam cooking device.

A cooking accessory for use in a steam cooking device is known from the document U.S. Pat. No. 3,528,401, that cooking accessory comprising a cooking receptacle and a steam passage zone. That cooking accessory makes it possible to cook foods in their juice inside the cooking receptacle. That document does not envisage any other type of cooking with the same accessory.

The object of the present invention is to offer a cooking accessory that makes it possible to cook foods either in their juice or separately from their juice.

Another object of the invention is to produce a cooking accessory that stops the juice from flowing into lower elements disposed underneath said cooking accessory, particularly when these lower elements contain food.

Another object of the invention is to economically produce a cooking accessory for a steam cooking device.

Another object of the invention is to offer a steam cooking device equipped to receive a cooking accessory of the aforementioned type.

These objects are achieved with a cooking accessory, particularly for use in a steam cooking device, said cooking accessory comprising a cooking receptacle and a steam passage zone, characterized in that the cooking accessory is reversible and in that the cooking accessory has, in the inverted position, a cooking zone adjacent to a juice collecting zone, the cooking zone and the juice collecting zone having no flow-through passages.

When used in a steam-cooking device, such a cooking accessory makes it possible to cook foods in their juice by placing the foods in the cooking receptacle that occupies the top side of the cooking accessory. The juices are then retained in the cooking receptacle. When inverted, such a cooking accessory makes it possible to cook foods separately from their juice in the cooking zone, which in that case occupies the top side of the cooking accessory. The juices can flow from the cooking zone into the juice collecting zone due to the fact that they are adjacent.

In both of the aforementioned cooking methods, the foods are partly cooked by the steam that passes through one or more perforations of the steam passage zone.

The reversibility of the cooking accessory thus makes it possible to cook foods using two cooking methods with a single accessory: cooking in the juice and cooking separately from the juice.

When cooking separately from the juice, the juices are collected by the juice collecting zone, which has no flow-through passages, i.e. no passages that make it possible to pass from one side of the cooking accessory to the other.

The purpose of the juice collecting zone is to retain the juices so as to stop the juice from flowing into the lower elements. Thus, during simultaneous cooking, the flavors do not mix and each dish has an optimal taste.

Such a cooking accessory has a simple structure that is economical to produce.

Preferably, a rib separates the cooking receptacle and the steam passage zone.

When the foods are placed in the cooking receptacle, the rib retains the juices in the cooking receptacle.

Advantageously, the rib is annular.

This structure is advantageous for retaining the juices in the cooking receptacle.

Preferably, the annular rib surrounds the cooking receptacle.

Thus, when the elements are placed in the cooking receptacle, the juices are retained in the cooking receptacle by a rib that bounds the entire periphery of the cooking receptacle.

According to an advantageous embodiment, the inverted rib forms a groove that creates the juice collecting zone.

This geometry of the rib makes it possible to simplify the production of the cooking accessory.

Preferably, the cooking receptacle and the cooking zone have an elongated shape.

Such a cooking accessory is particularly suitable for cooking elongated foods such as fish.

Advantageously, the cooking zone is inclined toward the juice collecting zone.

This geometry of the cooking zone, on which the foods are placed when being cooked separately from the juice, facilitates the flow of the juices toward the juice collecting zone.

Preferably, a metal part forms the cooking receptacle, the cooking zone and the juice collecting zone.

Making this part from a metal material makes it possible to optimize the heat exchange with the foods. Thus, the foods are cooked by the steam passing through the steam passage zone and by heat conduction at the level of the cooking receptacle when cooking in the juice, or at the level of the cooking zone when cooking separately from the juice.

Advantageously, the metal part includes the steam passage zone.

This structure makes it possible to limit the width required to accommodate the perforations of the steam passage zone and thus to maximize the surface area of the cooking zone and the cooking receptacle.

Advantageously, the metal part is coated with a nonstick material.

Thus, the foods do not stick to the cooking receptacle when cooking in the juice, or to the cooking zone when cooking separately from the juice.

Advantageously, the cooking accessory comprises a peripheral collar obtained by overmolding plastic material onto the metal part.

The plastic overmolding makes it possible to limit the temperature of the peripheral collar and thus facilitates the grasping of the cooking accessory. The plastic overmolding also makes it possible to simplify the structure of the cooking accessory.

According to another feature of the cooking accessory, the cooking accessory comprises a peripheral collar.

This structure is advantageous for mounting the cooking accessory inside a steam cooking device and for producing an impermeable seal.

According to an advantageous embodiment, the peripheral collar supports grasping elements.

The grasping elements facilitate handling of the cooking accessory.

Preferably, the peripheral collar has two symmetrical annular edges.

The symmetry of the upper and lower annular edges makes it possible to position the cooking accessory in a similar receiving zone whether or not the cooking accessory is inverted. This symmetry simplifies the reversibility of the accessory.

Advantageously, a steam cooking device comprising a cooking accessory of the aforementioned type includes a lower element on which the cooking accessory is disposed and an upper element disposed on the cooking accessory, the lower element comprising an annular edge forming a groove provided for receiving either the upper element or the cooking accessory in either of its positions.

Thus, a single groove makes it possible to receive the cooking accessory in both of its positions, and alternately, to receive the upper element or the lower element directly when the steam cooking device is used without the cooking accessory.

Preferably, a steam cooking device comprising a cooking accessory of the aforementioned type comprises a lower element on which the cooking accessory is disposed and an upper element disposed on the cooking accessory, the lower element comprising an annular edge forming a groove provided for receiving either the upper element or the cooking accessory in either of its positions, the annular edges of the cooking accessory being provided for cooperating with both an annular support surface of the upper element and an annular support surface of the lower element.

This geometry makes it possible to optimize the impermeability of the seals between the cooking accessory and the upper and lower elements.

The objects, features and advantages of the present invention will be more clearly understood based on the description given below of two particular embodiments of the invention presented as nonlimiting examples in reference to the attached drawings, in which:

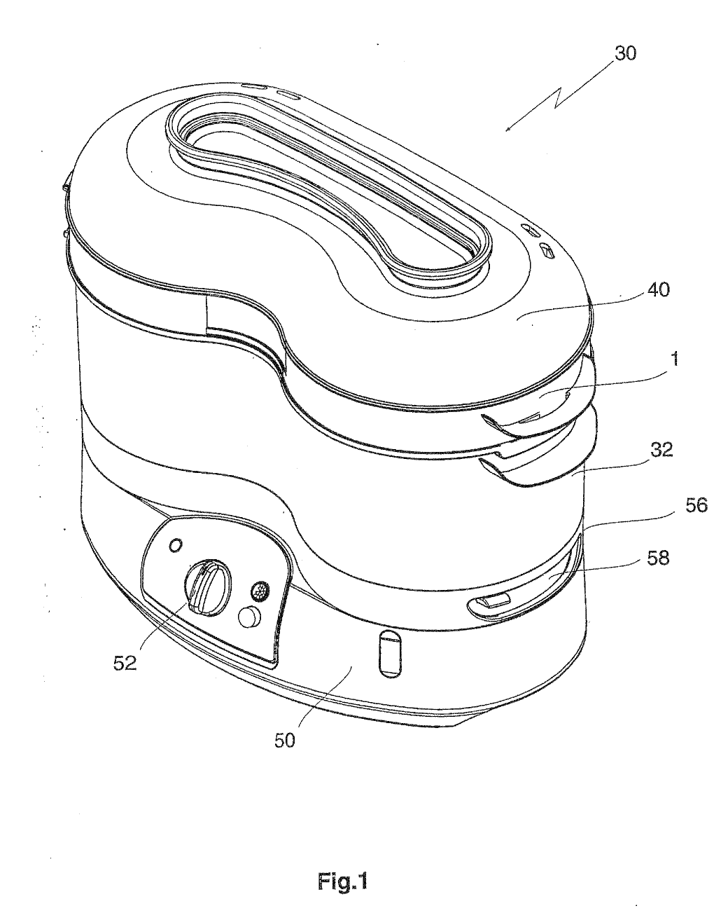

FIG. 1 is a perspective view of a first exemplary embodiment of a steam cooking device receiving a cooking accessory according to the invention;

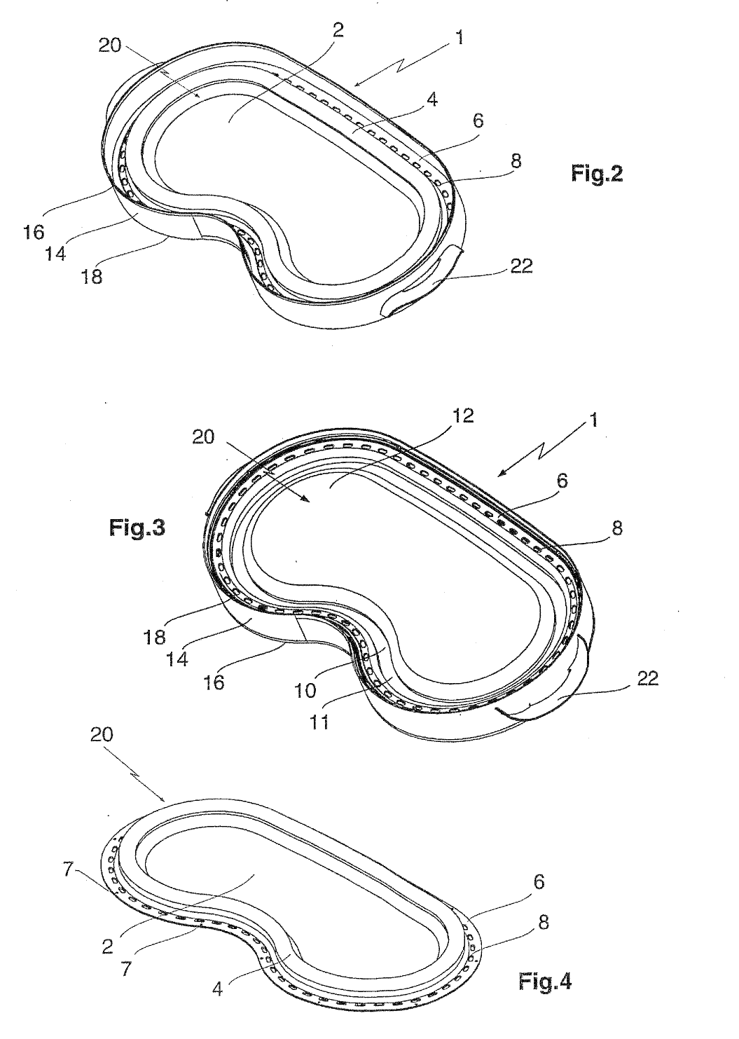

FIG. 2 is a perspective view of the cooking accessory for the steam cooking device shown in FIG. 1, in the position for cooking in the juice;

FIG. 3 is another perspective view of the cooking accessory for the steam cooking device shown in FIG. 1, in the position for cooking separately from the juice;

FIG. 4 is a perspective view of a part of the cooking accessory illustrated in FIGS. 1, 2, and 3, the peripheral collar of the cooking accessory not being shown;

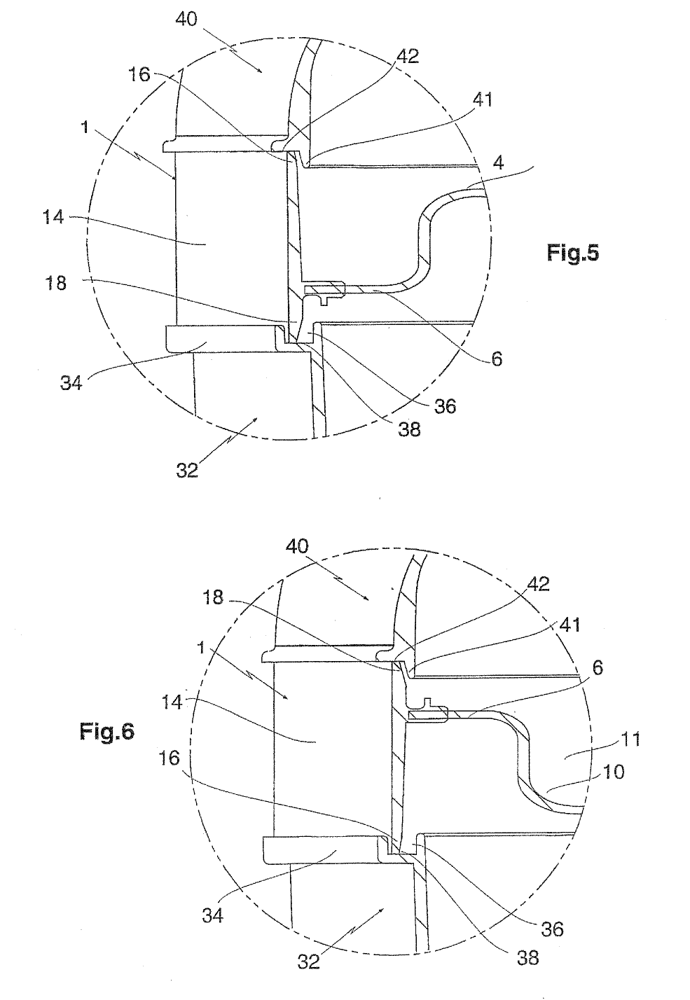

FIG. 5 is a detail view in vertical cross section of the steam cooking device shown in FIG. 1 in which the cooking accessory is positioned for cooking foods in their juice;

FIG. 6 is a detail view in vertical cross section of the steam cooking device shown in FIG. 1 in which the cooking accessory is positioned for cooking foods separately from their juice:

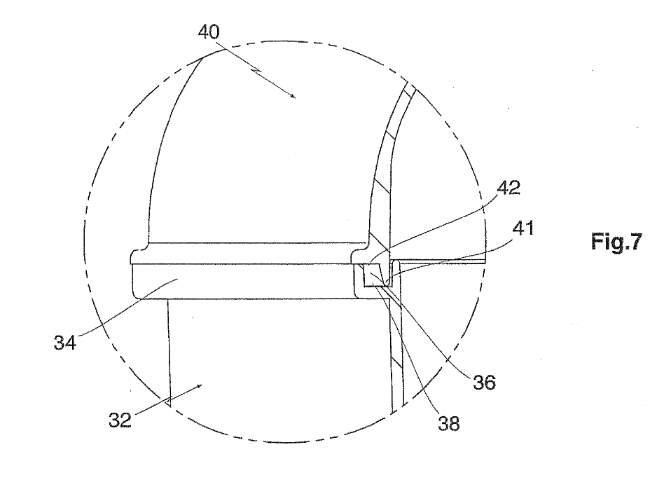

FIG. 7 is a detail view in vertical cross section of the steam cooking device shown in FIG. 1 in which the cooking accessory illustrated in FIGS. 1 through 6 has been removed;

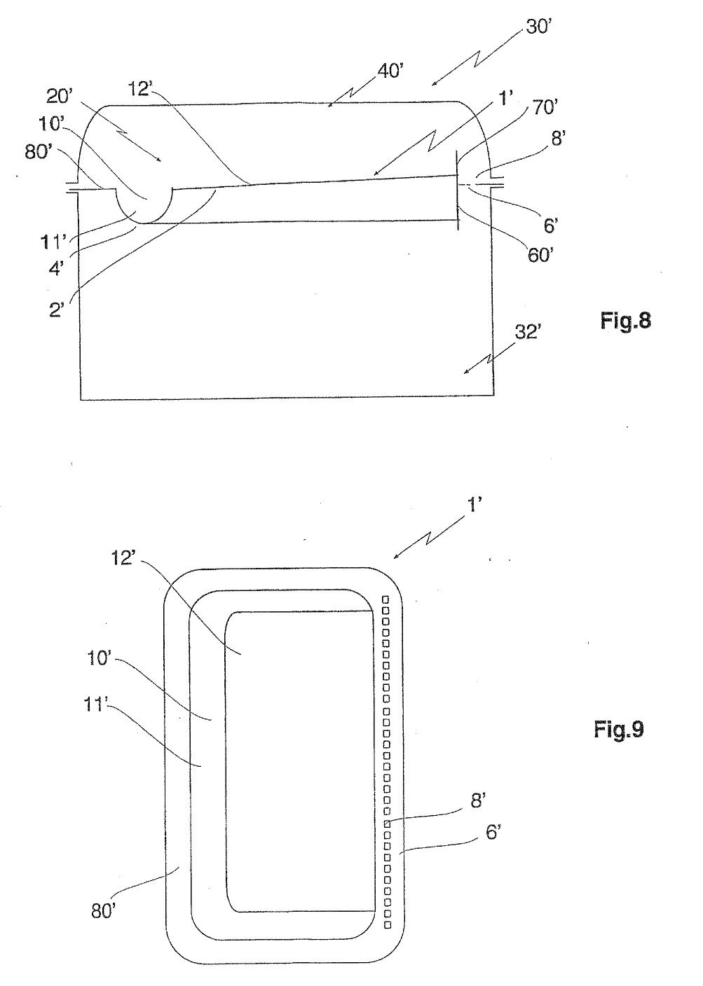

FIG. 8 is a schematic view in vertical cross section of a second exemplary embodiment of a steam cooking device receiving a cooking accessory according to the invention;

FIG. 9 is a schematic top view of the cooking accessory for the steam cooking device shown in FIG. 8, in the position for cooking separately from the juice.

Only the elements required for the understanding of the invention have been illustrated. To facilitate the reading of the drawings, the same elements have the same references from one figure to another.

The same exemplary embodiment is illustrated in FIGS. 1 through 7, which relate to a cooking accessory 1, particularly for use in a steam cooking device 30.

As illustrated in FIG. 1, the steam cooking device 30 comprises a base 50 surmounted by a juice collecting tray 56. The base 50 forms a water tank and includes a flat heating element (not visible in the figures) and a control element 52. The juice collecting tray 56 includes a laterally filling drawer 58 that communicates with the water tank.

The steam cooking device 30 also includes a cooking accessory l, a lower element 32 on which the cooking accessory 1 is disposed, and an upper element 40 disposed on the cooking accessory 1.

More particularly, the lower element 32 is a cooking bowl with a perforated bottom that defines a cooking chamber. The upper element 40 is a cover.

As illustrated in FIGS. 1, 2, 3 and 4, the cooking accessory 1, particularly for use in the steam cooking device 30, comprises a cooking receptacle 2 and a steam passage zone 6. The steam passage zone 6 forms a peripheral structure.

The steam passage zone 6 is equipped with perforations 8 for the passage of the steam contributing to the cooking of the food. More particularly, the steam passage zone 6 is equipped with several uniformly distributed perforations 8.

A rib 4 separates the cooking receptacle 2 and the steam passage zone 6. The rib 4 is protuberant relative to the cooking receptacle 2. The cooking accessory 1 thus makes it possible to cook foods in their juice by placing said foods in the cooking receptacle 2. In this method of cooking in the juice, which corresponds to FIG. 2, the juices are retained in the cooking receptacle 2 by the rib 4. The cooking juices are thus prevented from falling into a lower element disposed underneath the cooking accessory 1. More particularly, the rib 4 is annular. The rib 4 surrounds the cooking receptacle 2.

Specifically, according to the invention, the cooking accessory 1 is reversible.

For cooking separately from the juice, also called cooking without the juice, as illustrated in FIG. 3, the cooking accessory 1 is inverted relative to the position for cooking in the juice, illustrated in FIG. 2.

The cooking accessory 1 in the inverted position has a cooking zone 12 adjacent to a juice collecting zone 10; the cooking zone 12 and the juice collecting zone 10 being free of any flow-through passages. The foods are placed in the cooking zone 12, which is protuberant relative to the juice collecting zone 10. The juice collecting zone 10 retains the juices and makes it possible to prevent the juices from flowing into a lower element disposed underneath the cooking accessory 1. The cooking zone 12 is inclined toward the juice collecting zone 10 in order to facilitate the flow of the juices toward the juice collecting zone 10.

The inverted rib 4 forms a groove 11 that creates the juice collecting zone 10. More particularly, the inverted rib 4 forms an annular shaped groove 11 that creates the juice collecting zone 10 disposed on the periphery of the cooking zone 12.

The cooking receptacle 2 and the cooking zone 12 have an elongated shape.

The cooking accessory 1 comprises a peripheral collar 14, more particularly visible in FIGS. 2, 3, 5 and 6. The peripheral collar 14 surrounds the steam passage zone 6.

The peripheral collar 14 comprises two symmetrical annular edges 16 and 18. The annular edges 16, 18 alternately form lower and upper edges and vice versa, depending on the position of the cooking accessory 1. More particularly, the peripheral collar 14 comprises an annular edge 16 on the side of the cooling receptacle 2 and an annular edge 18 on the side of the cooking area 12.

The peripheral collar 14 supports grasping elements 22. The grasping elements 22 are composed of grasping handles placed symmetrically relative to the cooking accessory 1 so as to facilitate the handling of the cooking accessory in both of its positions. The grasping elements 22 are placed outside the cooking chambers defined by the lower element 32 and the cooking accessory 1 or by the cooking accessory 1 and the upper element 40.

A metal part 20 forms the cooking receptacle 2, the cooking zone 12 and the juice collecting zone 10. More particularly, the metal part 20 forms the cooking receptacle 2, the cooking zone 12, the juice collecting zone 10, the annular rib 4, and the steam passage zone 6 equipped with the perforations 8. The metal part 20 is illustrated in FIG. 4.

The metal material constituting the metal part 20 makes it possible to optimize the heat exchange between the food and the cooking receptacle 2 when cooking in the juice, and between the food and the cooking zone 12 when cooking separately from the juice, in order to cook the food partly by conduction.

More particularly, the metal part 20 is made of aluminum. As a variant, the metal part 20 can be made from, among other things, stainless steel.

The metal part 20 is coated with a nonstick material. More particularly the metal part is coated with PTFE.

The peripheral collar 14 is advantageously obtained by overmolding plastic material onto the metal part 20. More particularly, the plastic material is polypropylene. The steam passage zone 6 has openings 7 for the anchoring of the plastic overmolding. The openings 7 are illustrated in FIG. 4.

FIGS. 5, 6. 7 illustrate details of vertical sectional views of the steam cooking device 30 shown in FIG. 1. In FIG. 5, the cooking accessory 1 is placed in the direction for cooking in the juice. In FIG. 6, the cooking accessory 1 is placed in the direction for cooking separately from the juice. In FIG. 7, the cooking accessory 1 is not present in the steam cooking device 30.

The lower element 32 comprises an annular edge 34 forming a groove 36 provided for receiving either the upper element 40 or the cooking accessory 1 in either of its positions. Thus, the upper element 40 and the cooking accessory 1 can alternately be disposed on the lower element 32.

As illustrated in FIG. 7, the groove 36 can receive the upper element 40 directly. The groove 36 can receive an annular edge 41 of the upper element 40.

As illustrated in FIG. 5, the groove 36 can receive the cooking accessory 1 in the position for cooking in the juice. The groove 36 can receive the annular edge 18 of the cooking accessory 1.

As illustrated in FIG. 6, the groove 36 can receive the cooking accessory 1 in the position for cooking separately from the juice. The groove 36 can receive the annular edge 16 of the cooking accessory 1.

The annular edges 16, 18 of the cooking accessory 1 are provided for cooperating with both an annular support surface 42 of the upper element 40 and an annular support surface 38 of the lower element 32.

As illustrated in FIG. 5, the annular edge 16 of the cooking accessory 1 cooperates with the annular support surface 42 of the upper element 40. The annular edge 18 of the cooking accessory 1 cooperates with the annular support surface 38 of the lower element 32. The groove 36 comprises the annular support surface 38.

As illustrated in FIG. 6, the annular edge 18 of the cooking accessory 1 cooperates with the annular support surface 42 of the upper element 42. The annular edge 16 of the cooking accessory 1 cooperates with the annular support surface 38 of the lower element 32.

Another exemplary embodiment, represented in FIGS. 8 and 9, relates to a cooking accessory 1′, particularly for use in a steam cooking device 30′.

As illustrated in FIG. 8, the steam cooking device 30′ comprises a cooking accessory 1′, a lower element 32′ on which the cooking accessory 1′ is disposed, and an upper element 40′ disposed on the cooking accessory 1′. More particularly, the lower element 32′ is a water tank. The upper element 30′ is a cover.

As illustrated in FIGS. 8 and 9, the cooking accessory 1′ comprises a cooking receptacle 2′ and a steam passage zone 6′ equipped with perforations 8′.

A wall 60′ separates the steam passage zone 6′ from the cooking receptacle 2′. The cooking receptacle 2′ is delimited by the wall 60′ and by the rib 4′. The cooking accessory 1′ has a peripheral edge 80′ extending around the wall 60′ and the rib 4′.

The cooking accessory 1′ thus makes it possible to cook foods in their juice by placing them in the cooking receptacle 2′. In this cooking method, the juices are retained by the rib 4′ and the wall 60′.

Specifically, according to the invention, the cooking accessory 1′ is reversible and has, in the inverted position, a cooking zone 12′ adjacent to a juice collecting zone 10 . The cooking zone 12′ and the juice collecting zone 10′ have no flow-through passages. The juice collecting zone 10′ retains the juices and makes it possible to prevent the juices from flowing into the lower element 32′. The cooking zone 12′ is inclined toward the juice collecting zone 10′ and is delimited both by the groove 11′ that creates the juice collecting zone 10′ and by a wall 70′. The wall 70′ is disposed in the extension of the wall 60′. The inverted rib 4′ forms the groove 11′ that creates the juice collecting zone 10′. The wall 60′ forms the lateral ends of the groove 11′.

The cooking accessory 1′ can be formed by a cast metal part 20′. The metal part 20′ forms the cooking receptacle 2′, the cooking zone 12′ and the juice collecting zone 10′. The metal part 20′ also comprises the steam passage zone 6′ equipped with the perforations 8′. The metal part 20 is coated with a nonstick material.

The cooking receptacle 2′ and the cooking zone 12′ have an elongated shape. The lack of a peripheral collar facilitates the serving of foods.

It is understood that the invention is in no way limited to the embodiments described and illustrated, which are given only as an example. Other modifications remain possible, particularly from the point of view of the structure of the various elements or the substitution of technical equivalents, without going beyond the scope of protection of the invention.

1. Cooking accessory (1; 1′), particularly for use in a steam cooking device (30; 30′), said cooking accessory (1; 1′) comprising a cooking receptacle (2; 2′) and a steam passage zone (6; 6′), characterized in that the cooking accessory (1; 1′) is reversible and in that the cooking accessory (1; 1′) has, in the inverted position, a cooking zone (12; 12′) adjacent to a juice collecting zone (10; 10′), the cooking zone (12; 12′) and the juice collecting zone (10′ 10′) having no flow-through passages.

2. Cooking accessory (1; 1′) according to claim 1, characterized in that a rib (4; 4′) separates the cooking receptacle (2; 2′) and the steam passage zone (6; 6′).

3. Cooking accessory (1) according to claim 2, characterized in that the rib (4) is annular.

4. Cooking accessory (1) according to claim 3, characterized in that annular rib (4) surrounds the cooking receptacle (2).

5. Cooking accessory (1; 1′) according to claim 2, characterized in that the inverted rib (4; 4′) forms a groove (11; 11 ′) that creates the juice collecting zone (10; 10′).

6. Cooking accessory (1; 1′) according to claim 1, characterized in that the cooking receptacle (2; 2′) and the cooking zone (12; 12′) have an elongated shape.

7. Cooking accessory (1; 1′) according to claim 1, characterized in that the cooking zone (12; 12′) is inclined toward the juice collecting zone (10; 10).

8. Cooking accessory (1; 1′) according to claim 1, characterized in that a metal part (20; 20′) forms the cooking receptacle (2; 2′), the cooking zone (12; 12′) and the juice collecting zone (10; 10′).

9. Cooking accessory (1; 1′) according to claim 8, characterized in that the metal part (20; 20′) includes the steam passage zone (6; 6′).

10. Cooking accessory (1; 1′) according to claim 8, characterized in that the metal part (20; 20′) is coated with a nonstick material.

11. Cooking accessory (1) according to claim 8, characterized in that it comprises a peripheral collar (14) obtained by overmolding plastic material onto the metal part (20).

12. Cooking accessory (1) according to claim 1, characterized in that it comprises a peripheral collar (14).

13. Cooking accessory (1) according to claim 11, characterized in that the peripheral collar (14) supports grasping elements (22).

14. Cooking accessory according to claim 11, characterized in that the peripheral collar (14) has two symmetrical annular edges (16, 18).

15. Steam cooking device (30) comprising a cooking accessory (1) according to claim 1, characterized in that it includes a lower element (32) on which the cooking accessory (1) is disposed and an upper element (40) disposed on the cooking accessory (1), the lower element (32) comprising an annular edge (34) forming a groove (36) provided for receiving either the upper element (40) or the cooking accessory (1) in either of its positions.

16. Steam cooking device (30) comprising a cooking accessory (1) according to claim 10, characterized in that it includes a lower element (32) on which the cooking accessory (1) is disposed and an upper element (40) disposed on the cooking accessory (1), the lower element (32) comprising an annular edge (34) forming a groove (36) provided for receiving either the upper element (40) or the cooking accessory (1) in either of its positions, and in that the annular edges (16, 18) of the cooking accessory (1) are provided for cooperating with both an annular support surface (42) of the upper element (40) and an annular support surface (38) of the lower element (32).
